(19) United States
(12) Patent Application Publication
(10) Pub. No.: US 2014/0035816 A1
(43) Pub. Date: Feb. 6, 2014

(54) PORTABLE APPARATUS

(71) Applicant: NOVATEK MICROELECTRONICS CORP., Hsinchu (TW)

(72) Inventors: Chia-Tai Liao, Hsinchu County (TW); Shih-Yang Cheng, Hsinchu City (TW)

(73) Assignee: NOVATEK MICROELECTRONICS CORP., Hsinchu (TW)

(21) Appl. No.: 13/659,933

(22) Filed: Oct. 25, 2012

(30) Foreign Application Priority Data
Aug. 3, 2012 (TW) 101128096

(51) Int. Cl. G06F 3/041; G06F 3/033

(52) U.S. Cl. 345/163; 345/173

(57) ABSTRACT

A portable apparatus including a touch display panel, a communication interface and a processing unit is provided. The processing unit generates first reference coordinates according to at least one touch point on the touch display panel, operates according to the first reference coordinates indicating a reference position in a frame displayed by the touch display panel, and generates first frame data to the touch display panel. When the communication interface is coupled to an external display apparatus, the processing unit generates second reference coordinates according to at least one touch point on the touch display panel, operates according to the second reference coordinates indicating a reference position in a frame displayed by the external display apparatus, and generates and transmits second frame data to the external display apparatus via the communication interface.

### CROSS-REFERENCE TO RELATED APPLICATION

This application claims the priority benefit of Taiwan application serial no. 101128096, filed on Aug. 3, 2012. The entirety of the above-mentioned patent application is hereby incorporated by reference herein and made a part of this specification.

### TECHNICAL FIELD

The disclosure relates to an electronic apparatus, and particularly relates to a portable electronic apparatus.

### BACKGROUND

Cell phones can be coupled to a personal computer via wireless communication. A user may install an application (App) on his/her cell phone and personal computer, so as to use the cell phone as the touchpad of the personal computer, thereby using the touch display panel of the cell phone to control operations of the external personal computer to display a frame. However, this known technique needs a personal computer to generate a frame data for displaying the corresponding frame. Furthermore, when the cell phone is externally coupled to the personal computer, the user needs to look at the screens of cell phone and personal computer alternately, which causes operating inconvenience.

### SUMMARY

The disclosure provides a portable apparatus that allows the user to focus on a frame of an external display apparatus when the portable apparatus is coupled to the external display apparatus, thereby improving operating convenience.

An embodiment of the disclosure provides a portable apparatus, including a touch display panel, a communication interface, and a processing unit. The processing unit is coupled to the touch display panel and the communication interface. When the communication interface and the external display apparatus are not coupled, the processing unit switches to a first operating mode. Under the first operating mode, the processing unit generates first reference coordinates according to at least one touch point on the touch display panel and operate with the first reference coordinates, the first reference coordinates indicating a reference position on a frame displayed by the touch display panel. Under the first operating mode, the processing unit generates first frame data for being transmitted to the touch display panel, such that the touch display panel displays a frame represented by the first frame data. When the communication interface and the external display apparatus are coupled, the processing unit switches to a second operating mode. Under the second operating mode, the processing unit generates second reference coordinates according to at least one touch point on the touch display panel and operate with the second reference coordinates, the second reference coordinates indicating a reference position on a frame displayed by the external display apparatus. Under the second operating mode, the processing unit generates second frame data for being transmitted to the external display apparatus via the communication interface, such that the external display apparatus displays a frame represented by the second frame data.

In an embodiment of the disclosure, under the first operating mode, the processing unit generates the first reference coordinates according to an absolute position on the touch display panel corresponding to the at least one touch point.

In an embodiment of the disclosure, under the second operating mode, the processing unit generates the second reference coordinates according to a relative position on the touch display panel corresponding to the at least one touch point.

In an embodiment of the disclosure, in the second operating mode, the processing unit generates the second reference coordinates according to a relative position generated by a pointing apparatus, the external display apparatus being coupled with or including the pointing apparatus.

In an embodiment of the disclosure, in the second operating mode, the processing unit receives pointing data corresponding to the relative position from the external display apparatus via the communication interface.

In an embodiment of the disclosure, the pointing apparatus is a mouse, a trackball, or a touchpad.

In an embodiment of the disclosure, under the second operating mode, the processing unit further receives an input signal from the external display apparatus via the communication interface, and performs a corresponding operation according to the input signal, wherein the input signal is obtained by being generated by an input apparatus and processed by the external display apparatus, the external display apparatus being coupled with or including the input apparatus.

In an embodiment of the disclosure, the input apparatus is a keyboard, a text input apparatus, or a touch pad.

In an embodiment of the disclosure, under the second operating mode, a cursor is displayed at the reference position indicated by the second reference coordinates in the frame represented by the second frame data. The cursor moves in response to a movement of the at least one touch point.

In an embodiment of the disclosure, under the first operating mode, no cursor is displayed at the reference position indicated by the first reference coordinates in the frame represented by the first frame data and displayed by the touch display panel.

In an embodiment of the disclosure, under the second operating mode, the second frame data is not transmitted to the touch display panel, such that the touch display panel does not display a frame in accordance with the second frame data.

In an embodiment of the disclosure, under the second operating mode, the processing unit further transmits third frame data to the touch display panel, such that the touch display panel displays a frame represented by the third frame data.

In an embodiment of the disclosure, the second frame data and the third frame data are at least partially identical.

In an embodiment of the disclosure, the second frame data and the third frame data are different.

In an embodiment of the disclosure, the touch display panel and the external display apparatus display a frame of an identical content when the communication interface and the external display apparatus are coupled.

In an embodiment of the disclosure, under the second operating mode, the touch display panel and the external display apparatus display frames of different contents.

In an embodiment of the disclosure, under the first operating mode, the frame displayed on the touch display panel has a first desktop layout configuration. Under the second operating mode, the frame displayed on the external display apparatus has a second desktop layout configuration. The first desktop layout configuration is different from the second desktop layout configuration.

In an embodiment of the disclosure, for same image data, a single frame displayed by the external display apparatus under the second operating mode, as compared to a single frame displayed by the touch display panel under the first operating mode, displays more data in the same image data.

In an embodiment of the disclosure, the more data indicates more page data or more desktop data.

In an embodiment of the disclosure, the more page data includes data of a larger area in a single page data, or data of more pages in data of a plurality of pages.

In an embodiment of the disclosure, the more desktop data indicates more data of desktop icon in a single desktop data.

In an embodiment of the disclosure, under the first operating mode, at least one touch-control operating gesture on the touch display panel is associated to at least one corresponding operation with a first corresponding relation. Under the second operating mode, at least one touch-control operating gesture on the touch display panel is associated to at least one corresponding operation with a second corresponding relation. The first corresponding relation differs from the second corresponding relation.

In an embodiment of the disclosure, under the second operating mode, the frame represented by the second frame data comprises one or more operating links respectively corresponding to one or more operating programs, the processing unit responding to an operating gesture of starting on the touch display panel by starting an operating program corresponding to the operating link located at the second reference coordinates.

In an embodiment of the disclosure, under the second operating mode, the processing unit responds to an operating gesture of enlarging or shrinking on the touch display panel by enlarging or shrinking a partial area comprising the second reference coordinates.

In an embodiment of the disclosure, a communication protocol run by the communication interface comprises a mobile high-definition link (MHL), a high-definition multimedia interface (HDMI), a universal serial bus (USB), or an Intel wireless display (WiDi).

In an embodiment of the disclosure, under the second operating mode, the processing unit adjusts a resolution of the second frame data according to a resolution sent back from the external display apparatus.

Based on the above, an embodiment of the disclosure provides a portable apparatus that determines whether the processing unit switches to the first operating mode or the second operating mode according to whether the portable apparatus is coupled to the external display apparatus. Under the first operating mode, the processing unit generates first reference coordinates according to at least one touch point on the touch display panel and operates with the first reference coordinates, wherein the first reference coordinates indicates a reference position on a frame displayed by the touch display panel. Under the second operating mode, the processing unit generates second reference coordinates according to at least one touch point on the touch display panel and operates with the second reference coordinates, wherein the second reference coordinates indicates a reference position on a frame displayed by the external display apparatus. Therefore, when the portable apparatus and the external display apparatus are coupled, the user is allowed to focus on the frame of the external display apparatus, so the operating convenience is improved.

In order to make the aforementioned features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic circuit block diagram illustrating a portable apparatus and an external display apparatus according to an embodiment of the disclosure.

FIG. 2 is a schematic flowchart illustrating a method of operating a portable apparatus according to an embodiment of the disclosure.

FIG. 3 is a schematic scenario diagram illustrating the portable apparatus and the external display apparatus of FIG. 1 according to an embodiment of the disclosure.

FIG. 4 is a schematic scenario diagram illustrating the portable apparatus and the external display apparatus of FIG. 1 according to another embodiment of the disclosure.

FIG. 5 is a schematic scenario diagram illustrating the portable apparatus and the external display apparatus of FIG. 1 according to still another embodiment of the disclosure.

FIG. 6 is a schematic circuit block diagram illustrating a portable apparatus and an external display apparatus according to another embodiment of the disclosure.

FIG. 7 is a schematic flowchart illustrating a method of operating a portable apparatus according to another embodiment of the disclosure.

### DETAILED DESCRIPTION OF DISCLOSED EMBODIMENTS

Throughout the specification and the appended claims, the term “coupling” refers to any direct or indirect connecting means. For example, if it is described in the text that a first apparatus is coupled to a second apparatus, the intended interpretation is that in some embodiments, the first apparatus may be directly connected to the second apparatus, whereas in some other embodiments, the first apparatus may be indirectly connected to the second apparatus via another apparatus or some kind of connecting means.

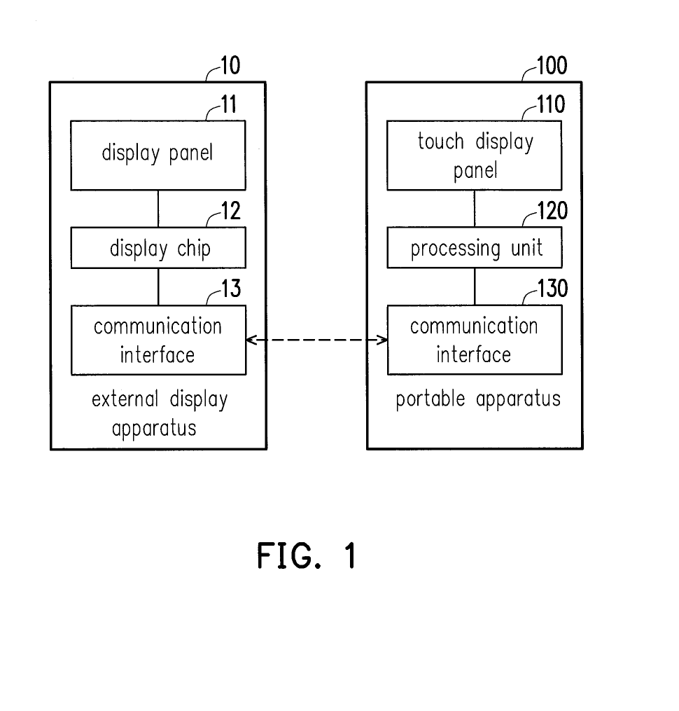

FIG. 1 is a schematic circuit block diagram illustrating a portable apparatus 100 and an external display apparatus 10 according to an embodiment of the disclosure. The external display apparatus 10 may be a television, a monitor, a projector, or other display apparatus. In this embodiment, the external display apparatus 10 includes a display panel 11, a display chip 12, and a communication interface 13. The display chip 12 can be coupled to the display panel 11 and the communication interface 13. The display chip 12 may receive a frame data output by an external apparatus (e.g. the portable apparatus 110) via the communication interface 13, and drive the display panel 11 based on the frame data, such that the display panel 11 displays a frame that the frame data represents.

The display panel 11 is, for example, a cathode ray tube (CRT) display, a liquid crystal display (LCD) panel, a plasma display panel (PDP), an organic light emitting diode (OLED) panel, or other display panels. If the external display apparatus 10 is a projector, the display panel 11 is, for example, a liquid crystal on silicon (LCOS) panel, a digital light processing (DLP) panel, or other display panels. An image beam from the display panel 11 may be projected out of the display apparatus 10 via an optical engine structure.

The communication interface 13 may be a wired communication interface or a wireless communication interface. The communication interface 13 described herein may refer to an interface or a plurality of interfaces. For example, the communication interface 13 may be a video graphics array (hereafter VGA) interface, a digital visual interface (hereafter DVI), a high-definition multimedia interface (hereafter HDMI), a universal serial bus (hereafter USB) interface, a mini-display port (hereafter mDP) interface, a mobile high-definition link (hereafter MHL) interface or other wired communication interfaces, or a combination thereof. Alternatively, the communication interface 13 may be a wide fidelity (hereafter WiFi) interface, an Intel wireless display (hereafter WiDi) interface, or other wireless communication interface, or a combination thereof.

The portable apparatus 100 may be a smartphone, a tablet computer, or other portable electronic apparatus having a touch panel. In this embodiment, the portable apparatus 100 includes a touch display panel 110, a processing unit 120, and a communication interface 130. The touch display panel 110 may be any kind of display panel having a touch-control function. The processing unit 120 is coupled to the touch display panel 110 and the communication interface 130. The processing unit 120 may communicate with an external apparatus via the communication interface 130. The communication interface 130 may be a wired or wireless communication interface, such as a VGA interface, a DVI, a HDMI, a USB interface, a mDP interface, a MHL interface, a WiFi interface, a WiDi interface, and so on. In some embodiments, when the portable apparatus 100 and the external display apparatus 10 are coupled, the external display apparatus 10 may charge the portable apparatus 100 via the communication interfaces 13 and 130 (e.g. USB).

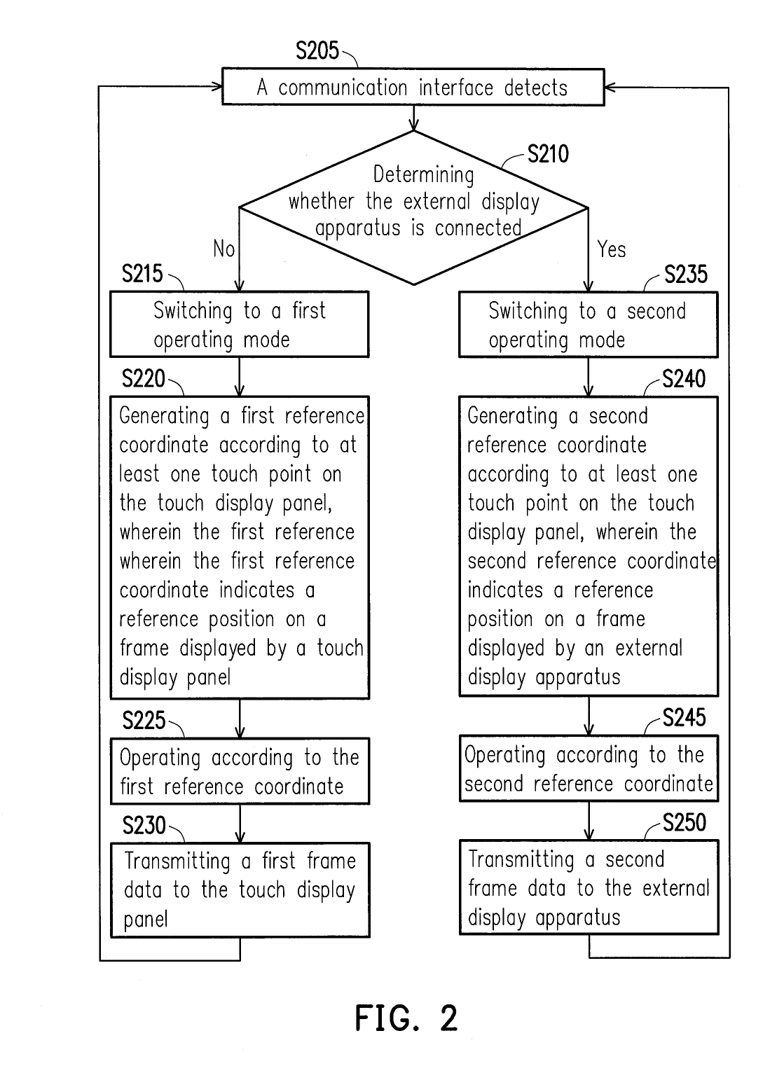

FIG. 2 is a schematic flowchart illustrating a method of operating the portable apparatus 100 according to an embodiment of the disclosure. Referring to FIGS. 1 and 2, at a step S205, the communication interface 130 detects whether there is a signal of an external apparatus. Therefore, the processing unit 120 may determine whether the portable apparatus 100 and the external display apparatus 10 are coupled according to a detection outcome of the communication interface 130 (step S210). When the communication interface 130 and the external display apparatus 10 are not coupled, the processing unit 120 switches to a first operating mode (step S215).

Under the first operating mode, the processing unit 120 generates first reference coordinates according to at one or more touch points touched by the user on the touch display panel 110 (step S220), wherein the first reference coordinates indicate a reference position in a frame displayed by the touch display panel 110. For example, under the first operating mode, the processing unit 120 generates the first reference coordinates according to an absolute position (actual position) of the touch point on the touch display panel 110.

After obtaining the first reference coordinates, the processing unit 120 may refer to the first reference coordinates to operate (step S225). For example, the processing unit 120 carries out a routine operation of a smartphone according to a gesture represented by the one or more touch points on the touch display panel 110. For example, if two touch points of the user on the touch display panel 110 represents an operating gesture of enlarging, the processing unit 120 may generate the first reference coordinates based on a center position between the two touch points, and the processing unit 120 responds to the operating gesture of enlarging by enlarging a partial area including the first reference coordinates. If a single touch point of the user on the touch display panel 110 represents an operating gesture of moving an object, the processing unit 120 generates the first reference coordinates according to a position of the single touch point, and the processing unit 120 responds to the operating gesture of moving by moving the object located at the position of the touch point. Therefore, according to operation at the step S225, the processing unit 120 may correspondingly generate first frame data to the touch display panel 110 (step S230), such that the touch display panel 110 displays a frame represented by the first frame data. After finishing the step S230, the portable apparatus 100 returns to the step S205. It should be noted that, under the first operating mode, a cursor may or may not be displayed at a reference position indicated by the first reference coordinates in the frame represented by the first frame data and displayed by the touch display panel 110.

At a step S210, when it is determined that the communication interface 130 builds a connection with the external display apparatus 10, the processing unit 120 switches to a second operating mode (step S235). Under the second operating mode, the processing unit 120 generates second reference coordinates according to one or more touch points touched by the user on the touch display panel 110 (step S240), wherein the second reference coordinates indicate a reference position in a frame displayed by the external display apparatus 10. For example, under the second operating mode, the processing unit 120 generates the second reference coordinates according to a relative position of the touch point on the touch display panel 110, wherein a position of the second reference coordinates does not represent the position of the touch point on the touch display panel 110, but indicates a reference position in the frame displayed on the external display apparatus 10. In addition, a movement of the second reference coordinates is responsive to a movement of the touch point on the touch display panel 110. Therefore, when the touch point on the touch display panel 110 moves, the reference position of the second reference coordinates on the frame displayed by the external display apparatus 10 moves accordingly. In other words, the processing unit 120 generates the second reference coordinates according to the relative position of the touch point on the touch display panel 110. A starting position of the second reference coordinates may be set at a center position of the frame displayed by the external display apparatus 10 or another predetermined position, for example.

After obtaining the second reference coordinates, the processing unit 120 may refer to the second reference coordinates to operate (step S245). The processing unit 120 may determine whether a gesture (e.g. defined by number, location, or moving direction) represented by the one or more touch points on the touch display panel 110 belongs to a movement, a click, a double click, or other gestures, so as to further operate correspondingly according to the second reference coordinates. For example, the user may move a cursor on the frame displayed by the external display apparatus 10 to an object (e.g. text, picture, button, etc.) on the display panel 11 by touching the touch display panel 110 of the portable apparatus 100. When the user performs a click, a double click, or other gestures at any position on the touch display panel 110 of the portable apparatus 100, the processing unit 120 may perform an action, such as choosing or starting a hyperlink, to an object located at a position of the cursor (i.e. the position of the second reference coordinate) on the frame displayed by the external display apparatus 10.

For example, if a single touch point of the user on the touch display panel 110 represents the operating gesture of moving, the processing unit 120 moves the reference position on the frame displayed by the external display apparatus 10, as indicated by the second reference coordinates, according to a moving direction of the single touch point on the touch display panel 110. If, under the second operating mode, two touch points on the touch display panel 110 represent the operating gesture of enlarging (or shrinking), the processing unit 120 responds to the operating gesture of enlarging (or shrinking) by enlarging (or shrinking) a partial area including the second reference coordinates.

Therefore, according to the operation at the step 245, the processing unit 120 may correspondingly generate second frame data. The second frame data is transmitted to the external display apparatus 10 via the communication interface 130 (step S250), such that the external display apparatus 10 displays a frame represented by the second frame data. After finishing the step S250, the portable apparatus 100 returns to the step S205.

It should be noted that, in some embodiment, communicative connection between the portable apparatus 100 and the external display apparatus 10 may be unidirectional. Namely, the portable apparatus 100 transmits the second frame data and other control commands to the external display apparatus 10. In some other embodiments, communicative connection between the portable apparatus 100 and the external display apparatus 10 may be bidirectional. When the portable apparatus 100 and the external display apparatus 10 are coupled, the portable apparatus 100 may receive a control command from the external display apparatus 10. In other words, the portable apparatus 100 has bidirectional communication with the external display apparatus 10 via the communication interfaces 13 and 130. For example, the portable apparatus 100 may read resolution, frequency, image en-/decryption information or other information of the external display apparatus 10 supported by the external display apparatus 10. When the communication interface 130 and the external display apparatus 10 are coupled, the external display apparatus 10 may send a resolution of the display panel 11 back to the portable apparatus 100. The processing unit 120 may adjust a resolution (or frame size) of the second frame data according to the resolution sent back from the external display apparatus 10.

In other words, when the portable apparatus 100 and the external display apparatus 10 are coupled, the display chip 12 may inform the portable apparatus 100 with a current state of the external display apparatus 100 and/or respond with information requested by the portable apparatus 100 via a control channel/bus between the communication interfaces 13 and 130. For example, the portable apparatus 100 may receive a resolution information of the display panel 11 from the external display apparatus 10 via the control channel/bus. In addition, the portable apparatus 100 transmits an image data to the external display apparatus 10 via a data channel/bus between the communication interfaces 13 and 130. It should be noted that the control channel/bus with which the external display apparatus 10 transmits the control command (e.g. the resolution information of the display panel 11 or other information) to the portable apparatus 100 and the data channel/bus with which the portable apparatus 100 transmits the frame data to the external display apparatus 10 may be two different channels/buses or the same channel/bus.

In this embodiment, the user may utilize the portable apparatus 100 for secretarial processing, multimedia playing, web-surfing, or applications with other functions. The user operates the touch display panel 110 to directly control the portable apparatus 100 itself, instead of controlling the external display apparatus 10. In other words, programs in connection with secretarial processing, multimedia playing, web-surfing, or applications with other functions may be stored in a memory apparatus (not shown) of the portable apparatus 100, instead of being stored in the external display apparatus 10. However, if a screen size of the touch display apparatus 110 is shrunk for the ease of carrying, the screen size of the touch display panel 110 may be too small to limit operating convenience of the touch display panel 110. Operations such as surfing on the web, editing documents, watching a film or other multimedia files may be more operationally convenient or has a more preferable viewing effect when being carried out with a larger frame. Therefore, the user may connect the external display apparatus 10 to the portable apparatus 100. When the portable apparatus 100 and the external display apparatus 10 are coupled, the portable apparatus 100 may transmit the data frame to the external display apparatus 10 via the communication interface 130, such that the external display apparatus 10 displays a frame represented by the frame data. Utilizing the external display apparatus 10 having a larger display area to display an image or a frame allows the user to conveniently surf on the web, play multimedia files, edit documents, or perform other operations with a more comfortable view.

It should be noted that when the communication interface 130 and the external display apparatus 10 are coupled, the touch display panel 110 may selectively display (or not display) a frame. For example, in some embodiments, under the second operating mode, the second frame data may not be transmitted to the touch display panel 110, such that the touch display panel 110 does not display a frame in accordance with the second frame data. Under this circumstance, the processing unit 120 may disable a display function of the touch display panel 110 to reduce power consumption. In some other embodiments, under the second operating mode, the processing unit 120 may further transmit third frame data to the touch display panel 110 in addition to transmitting the second frame data to the external display apparatus 10, such that the touch display panel 110 displays a frame represented by the third frame data. Based on different scenarios in which different embodiments are put into practice, the second frame data and the third frame data may be partially identical, completely identical, or completely not identical (or irrelevant). Therefore, when the communication interface and the external display apparatus are coupled, the touch display panel 110 and the external display apparatus 10 may display frames of an identical content or different or even irrelevant contents.

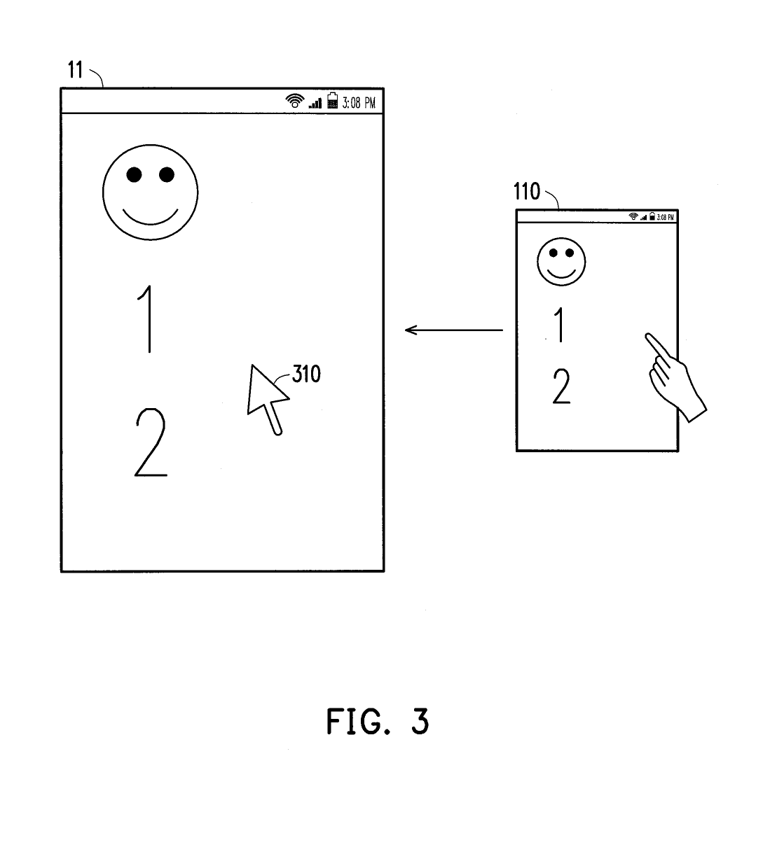

Under the second operating mode, the reference position indicated by the second reference coordinates may be indicated on the frame displayed on the external display apparatus 10 through any means (or not indicated) based on designing requirements of an actual product. For example, FIG. 3 is a schematic scenario diagram illustrating the portable apparatus 100 and the external display apparatus 10 of FIG. 1 according to an embodiment of the disclosure. Under the second operating mode, the external display apparatus 10 receives the second frame data provided by the portable apparatus 100, and the display panel 11 of the external display apparatus 10 displays the frame represented by the second frame data. In this embodiment, the touch display panel 110 of the portable apparatus 100 and the display panel 11 of the external display apparatus 10 display frames of an identical content, for example. As illustrated in FIG. 3, in the frame represented by the second frame data (i.e. the frame displayed in the display panel 11 of the external display apparatus 10), a cursor 310 is additionally displayed at the reference position indicated by the second reference coordinates. In addition, the cursor may not be displayed at the position indicated by the first reference coordinates on the touch display panel when the touch display panel displays the frame according to the first frame data under the first operating mode and/or the frame displayed according to the third frame data under the second operating mode.

A movement of the cursor 310 is responsive to the movement of the touch point on the touch display panel 110. The user may slide through the touch display panel 110 of the portable apparatus 100 with his/her finger(s) to move the cursor 310, so as to improve the operating convenience. For example, if a moving direction of the touch point on the touch display panel 110 is toward top right, the processing unit 120 correspondingly moves the cursor 310 (i.e. the reference position indicated by the second reference coordinate) toward top right. Given that the cursor 310 indicates that the reference position is located at a top right area of the frame displayed by the display panel 11 of the external display apparatus 10, although the operating gesture (touch points) of enlarging is performed at a center area of the touch display panel 110 of the portable apparatus 100, the processing unit 120 responds to the operating gesture of enlarging by enlarging a top right area that includes the cursor 310. Therefore, when the portable apparatus 100 and the external display apparatus 10 are coupled, the user may focus on the frame of the external display apparatus 10 without looking at the touch display panel 110, so operating convenience is improved.

Generally speaking, the resolution of the display panel 11 of the external display apparatus 10 may be higher than a resolution of the touch display panel 110 of the portable apparatus 100. When the portable apparatus 100 switches to the second operating mode, a frame resolution output by the portable apparatus 100 to the external display apparatus 10 may be optionally set, so as to output the frame data with a higher resolution. Moreover, in correspondence to the display panel 11 of the display apparatus 10 having a larger size, the portable apparatus 100 may have different desktop layouts (e.g. size of desktop, size, number, location, and/or arrangement of icons) for the user's choice. In other words, under the first operating mode, the frame displayed on the touch display panel 110 has a first desktop layout configuration. Under the second operating mode, the frame displayed on the external display apparatus 10 has a second desktop layout configuration. The first desktop layout configuration may be identical to or different from the second desktop layout configuration.

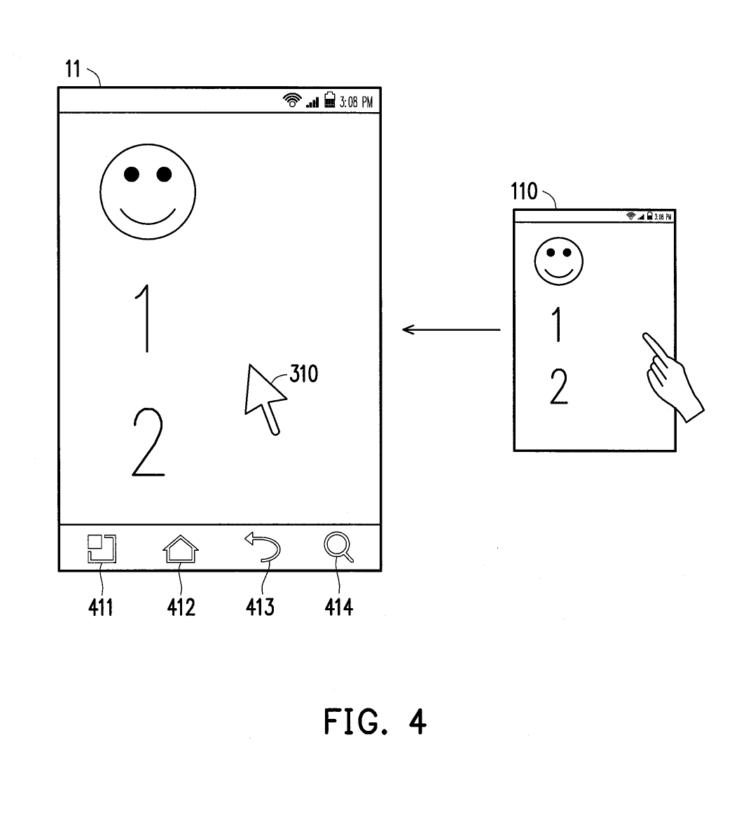

FIG. 4 is a schematic scenario diagram illustrating the portable apparatus 100 and the external display apparatus 10 of FIG. 1 according to another embodiment of the disclosure. The embodiment illustrated in FIG. 4 may refer to the relevant description of FIG. 3. In this embodiment, the frame displayed by the touch display panel 110 of the portable apparatus 100 and the frame displayed by the display panel 11 of the external display apparatus 10 are partially identical, for example. As illustrated in FIG. 4, compared to the frame displayed by the touch display panel 110, the frame displayed by the display panel 11 of the external display apparatus 10 further includes a control bar, wherein the control bar includes a plurality of control icons 411, 412, 413, and 414. The user may utilize the touch display panel 110 of the portable apparatus 100 to input an operating gesture, so as to move the cursor 310 displayed on the display panel 11 of the external display apparatus 10 to one of the control icons 411-414, thereby triggering the processing unit 120 of the portable apparatus 100 to perform a corresponding control function.

In other embodiments, the frame displayed by the display panel 11 of the external display apparatus 10 may further include one or more texts or operating links, wherein the operating links respectively correspond to one or more operations, such as starting an application, showing an operating menu, or linking to a webpage with a browser, etc. In response to an operating gesture of starting on the touch display panel 110, the processing unit 120 of the portable apparatus 100 starts an operating program corresponding to the operating link at the second reference coordinates (i.e. the position of the cursor 310) or downloads/displays a webpage whose address corresponds to the link.

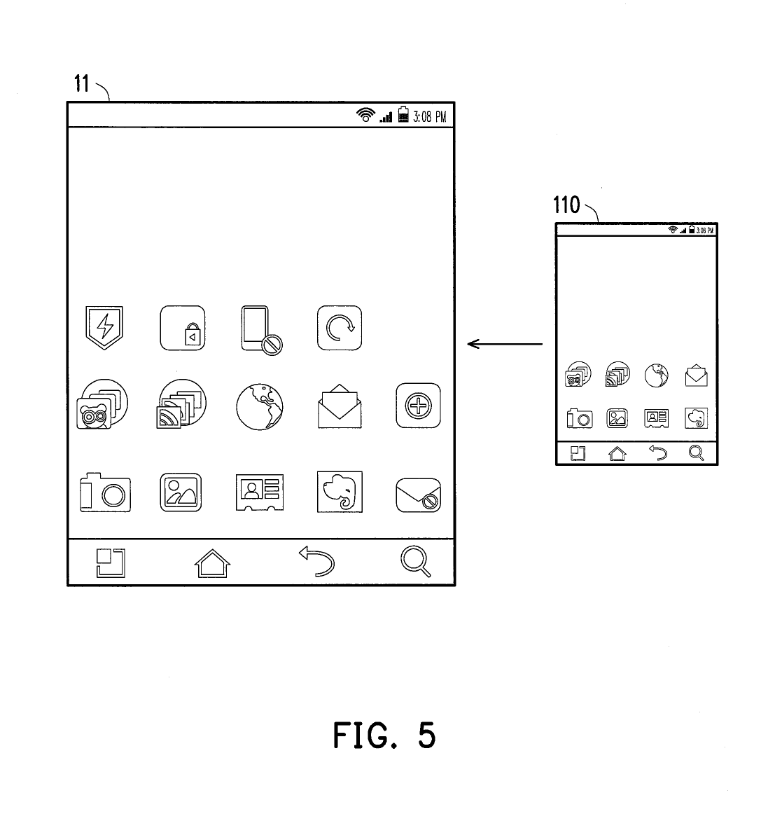

FIG. 5 is a schematic scenario diagram illustrating the portable apparatus 100 and the external display apparatus 10 of FIG. 1 according to still another embodiment of the disclosure. The embodiment illustrated in FIG. 5 may refer to relevant description of FIGS. 3 and 4. In this embodiment, under the first operating mode, the frame displayed by the touch display panel 110 has a first desktop layout configuration. For example, FIG. 5 illustrates a desktop/window displayed on the touch display panel 110 with m icon(s)/operating link(s) configured. For example, under the second operating mode, the frame displayed on the display panel 11 of the external display apparatus 10 has a second desktop layout configuration. For example, FIG. 5 illustrates a desktop/window displayed on the display panel 11 of the external display apparatus 10 with n icon(s)/operating link(s) configured, wherein n may be set to be larger or equal to m. In the embodiment illustrated in FIG. 5, m and n are respectively 8 and 14, for example. However, the disclosure is not limited thereto. Moreover, under the second operating mode, if the touch display panel 110 displays a frame, the frame displayed may be partially identical or different, as previously described.

Furthermore, in addition to a content of the desktop, the same description analogically applies to viewing of page contents of other types of files (e.g. document files). More specifically, the portable apparatus 100 usually has a plurality of pages, and the user may switch between different pages with his/her finger(s), so as to view different contents of the different pages. When the portable apparatus 100 and the external display apparatus 10 are coupled, the portable apparatus 100 may simultaneously display contents of a plurality of pages in a frame, such that the user is allowed to view more contents in a single page in one time.

Namely, for same source image data, a single frame displayed by the external display apparatus 10 in one time under the second operating mode displays “more data” of the same source image data compared to a single frame displayed by the touch display panel 110 under the first operating mode, wherein the term “more data” may be implemented as “more page data” or “more desktop data”. The term “more page data” may include data of a larger area in a single page data, or data of more pages in data of a plurality of pages. The term “more desktop data” may include more data of desktop icon (more desktop icons) in a single desktop data.

It should be noted that when the portable apparatus 100 and the external display apparatus 10 are coupled, the operation above does not influence other functions of the portable apparatus 100. For example, if the portable apparatus 100 is a cell phone having a multiplexing function, the user playing a movie with the cell phone 100 and outputting a frame of the movie to the external display apparatus 10, the external display apparatus 10 is allowed to display the frame of the movie and/or an operating page with a larger screen, and the user may utilize the touch display panel 110 of the cell phone 100 to control playing of the movie. If there is an incoming call when the movie is played, the user is allowed to utilize a relevant button of the cell phone 100 to take/hang up the phone call without influencing playing of the movie.

Under the second operating mode in this kind of embodiments, the processing unit 120 transmits a frame data of an incoming call operation to the touch display apparatus 100 in addition to transmitting the frame data of the movie to the external display apparatus 10. At this time, the frames displayed by the external display apparatus 10 and the touch display panel 110 are completely different. In other embodiments, when the portable apparatus 100 receives an incoming call, the frame displayed by the touch display panel 110 is split into a first part and a second part, wherein the first part is the frame of the incoming call operation, whereas the second part is a part or a whole part of the frame of the movie displayed by the external display apparatus 10.

In other embodiments, a determining condition of the step S210 illustrated in FIG. 2 may further include a choice of the user. When the portable apparatus 100 is coupled to the external display apparatus 10 and outputs the frame data to the external display apparatus 10, the touch display panel 110 of the portable apparatus 100 displays a notification message to inquire with the user whether the user wants to switch from the first operating mode (e.g. touch-control mode of absolute position) to the second operating mode (e.g. touch-control mode of relative position). As previously described, when the user chooses the second operating mode, the portable apparatus 100 may additionally display the cursor 310 on the touch display panel 110 and/or the display panel 11 of the external display apparatus 10. An initial position of the cursor 310 may be predetermined, such as being located at the center of the frame or other predetermined positions.

Moreover, regarding the operating gestures, at least one touch-control operating gesture on the touch display panel 110 is associated to at least one corresponding operation with a first corresponding relation under the first operating mode. Under the second operating mode, at least one touch-control operating gesture on the touch display panel 110 is associated to at least one corresponding operation with a second corresponding relation. The first corresponding relation differs from the second corresponding relation. For example, supposing that a touch-control operating gesture on the touch display panel 110 is a single touch point sliding downward, the operating gesture of the touch point sliding downward may enable the frame on the touch display panel 110 to be scrolled down under the first operating mode, whereas under the second operating mode, the same operating gesture (the touch point sliding down) on the touch display panel 110 enables the cursor in the frame displayed by the external display apparatus 10 to move downward. In other words, at least one same operating gesture may correspond to different operations, or at least one same operation may correspond to different operating gestures.

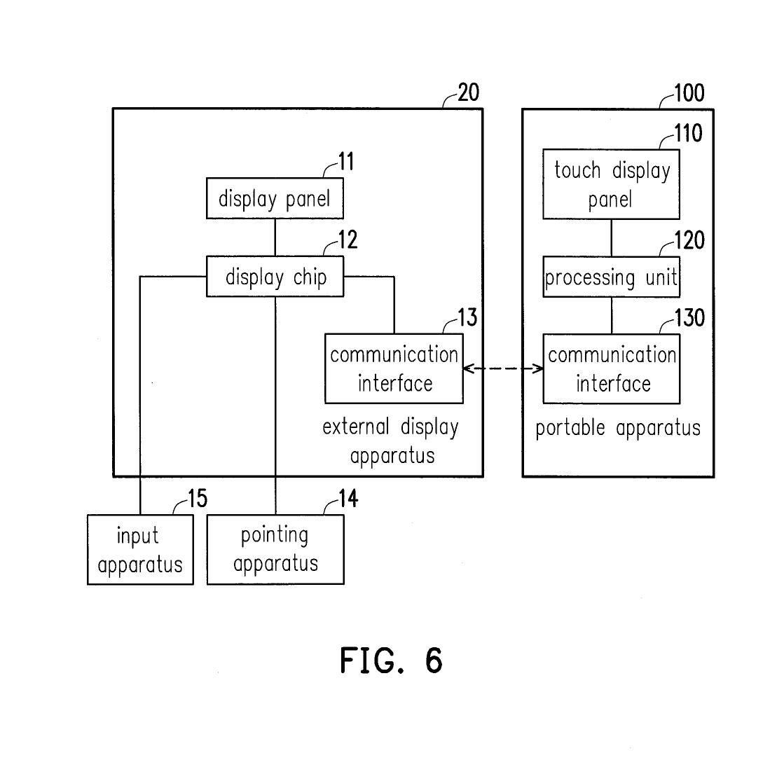

FIG. 6 is a schematic circuit block diagram illustrating the portable apparatus 100 and an external display apparatus 20 according to another embodiment of the disclosure. The external display apparatus 20 may be a smart TV, a monitor of a computer, a projector, or other display apparatus. The portable apparatus 100 and the external display apparatus 20 illustrated in FIG. 6 may refer to relevant description of the portable apparatus 100 and the external display apparatus 10 of FIG. 1. A difference from the external display apparatus 10 illustrated in FIG. 1 is that the external display apparatus 20 illustrated in FIG. 6 is further coupled with a pointing apparatus 14 and/or an input apparatus 15.

Referring to FIG. 6, the pointing apparatus 14 and/or the input apparatus 15 are coupled with the display chip 12 of the external display apparatus 20. The pointing apparatus 14 may include a mouse, a trackball, a touchpad, or a track pad. The pointing apparatus 14 may detect a user operating action to generate information of “relative position”, and the display chip 12 may convert the information of “relative position” to pointing data. To be used with the pointing apparatus 14, the external display apparatus 20 may include an interface converter (which may be integrated within the display chip 12, for example) (not shown). The interface converter may convert an output (e.g. a PS2 or USB signal) of the pointing apparatus 14 (e.g. a mouse) into a data format suitable to be transmitted to the communication interface 130 via the communication interface 13. The pointing data of the pointing apparatus 14 may follow a protocol that the display chip 12 receives, such as universal asynchronous receiver-transmitter (UART), serial peripheral interface (SPI), inter-integrated circuit (I²C), or other protocols.

In this embodiment, the communicative connection between the portable apparatus 100 and the external display apparatus 20 is bidirectional. When the portable apparatus 100 and the external display apparatus 20 are coupled, the portable apparatus 100 may receive a control command from the external display apparatus 20. For example, under the second operating mode, the display chip 12 may transmit the pointing data to the portable apparatus 100 via the communication interface 13. The processing unit 120 of the portable apparatus 100 may receive the pointing data provided by the external display apparatus 20 via the communication interface 130, and generate the second reference coordinates according to the pointing data. Therefore, the processing unit 120 of the portable apparatus 100 follows a “relative position” generated by the pointing apparatus 14 of the external display apparatus 20 to generate the second reference coordinates under the second operating mode, wherein the second reference coordinates indicate the reference position on the frame displayed by the external display apparatus 20. Consequently, the user may input with the touch display panel 110 of the portable apparatus 100, and/or may input with the pointing apparatus 14 coupled with the external display apparatus 20. Moreover, in some other embodiments, the portable apparatus 100 may be externally coupled to another pointing apparatus for the user to input. The user may input with the touch display panel 110 and/or the pointing apparatus of the portable apparatus 100, and/or may use the pointing apparatus 14 coupled with the external display apparatus 20 to input.

For another example, under the second operating mode, the processing unit 120 further receives an input signal from the external display apparatus 20 via the communication interface 130, and performs a corresponding operation according to the input signal, wherein the input signal is obtained by being generated by the input apparatus 15 and processed by the external display apparatus 20, wherein the external display apparatus 20 is coupled with or includes the input apparatus 15. The input apparatus 15 may include a keyboard, a text input apparatus, or a touchpad. In other embodiments, in order to be used with the input apparatus 15, the external display apparatus 20 may include an interface converter (which may be integrated inside the display chip 12, for example) (not shown). The interface converter may convert an output (e.g. a PS2 or USB signal) of the keyboard into a data format (e.g. UART, SPI, I2C, or other protocols) suitable to be transmitted to the communication interface 130 via the communication interface 13. The user may input text into the portable apparatus 100 by operating with the input apparatus 15. In other embodiments, the portable apparatus also has a keyboard for the user to input text. The user may input with the keyboard of the portable apparatus 100, and/or may use the input apparatus 15 coupled with the external display apparatus 20 to input text.

In another embodiment, the input apparatus 15 may be or may further include an imaging apparatus. The imaging apparatus may photograph a user image. The display chip 12 may receive the user image photographed by the imaging apparatus and analyze the user image to obtain user gesture data. When the communication interface 130 and the external display apparatus 20 are coupled, the processing unit 120 of the portable apparatus 100 may receive the user gesture data provided by the external display apparatus 20 via the communication interface 130 and move the position of the cursor 310 illustrated in FIG. 3 according to the user gesture data. The processing unit 120 may also perform an operation corresponding to the user gesture data, such as starting an application located at the position of the cursor 310, or enlarging an image located at the position of the cursor 310.

It should be noted that the data channel/bus with which the portable apparatus 100 transmits the frame data to the external display apparatus 20 and the control channel/bus with which the external display apparatus 20 transmits the control command (e.g. the pointing information, input signal, user gesture data or other information) to the portable apparatus 100 may be two different channels/buses or the same channel/bus. The display chip 12 transmits the control command to the portable apparatus 100 via the control channel/bus. The portable apparatus 100 may respond in accordance with the control command that is transmitted thereto, and transmit the image data to the external display apparatus 20 via the data channel. In addition, it should be noted that in some other embodiments, the pointing apparatus 14 or the input apparatus 15 may not be arranged as being coupled with the external display apparatus 20 but configured as elements of the external display apparatus 20 itself.

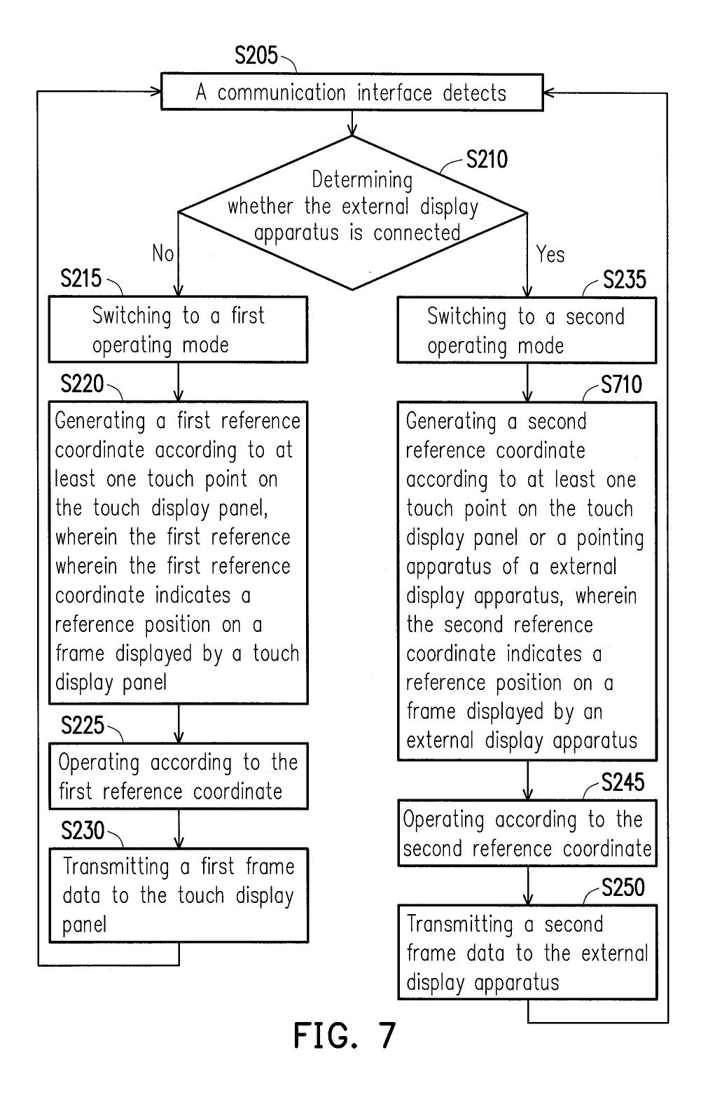

FIG. 7 is a schematic flowchart illustrating a method of operating the portable apparatus 100 according to another embodiment of the disclosure. The embodiment illustrated in FIG. 7 may refer to relevant description of FIG. 2. The difference from the embodiment illustrated in FIG. 2 is that a step S710 replaces the step S240 in the embodiment illustrated in FIG. 7. Referring to FIGS. 6 and 7, at step 710, the processing unit 120 may generate/move the second reference coordinates according to the one or more touch points on the touch display panel 110 touched by the user or generate/move the second reference coordinates according to the “relative position” generated by the pointing apparatus 14 of the external display apparatus 20 operated by the user under the second operating mode, wherein the second reference coordinates indicate the reference position in the frame displayed by the external display apparatus 20. In some embodiments, the touch display panel 110 and the pointing apparatus 14 may both be utilized to generate the second reference coordinates. In other embodiment, only one of the touch display panel 110 and the pointing apparatus 14 is utilized to generate the second reference coordinates. More specifically, in response to coupling or starting of the pointing apparatus, an apparatus that is utilized to generate the second reference coordinates may be switched from the touch display panel 110 to the pointing apparatus 14. Moreover, in response to non-coupling or not being started of the pointing apparatus, it may be that only the touch display apparatus 110 is utilized to generate the second reference coordinates.

Similarly, in this embodiment, the user touch-controls the touch display panel 110 to directly control the portable apparatus 100 itself, instead of controlling the external display apparatus 20. In other words, programs in connection with secretarial processing, multimedia playing, web-surfing, or applications with other functions may be stored in a memory apparatus (not shown) of the portable apparatus 100, instead of being stored in the external display apparatus 20. When the portable apparatus 100 and the external display apparatus 20 are coupled, the portable apparatus 100 may transmit the frame data to the external display apparatus 20 via the communication interface 130, such that the external display apparatus 20 displays the frame represented by the frame data. Utilizing the external display apparatus 20 having a larger display area to display an image or a frame allows the user to conveniently surf on the web, play multimedia files, edit documents, or perform other operations with a more comfortable view. Besides, the user may utilize the pointing apparatus 14 and/or the input apparatus 15 (e.g. a conventional keyboard and mouse) of the external display apparatus 20 to operate/control the portable apparatus 100.

In some embodiments, under the second operating mode, a driver of the touch display panel 110 may be appropriately modified to meet one or more requirements of the following requirements.

1. When the user puts his/her finger(s) on the touch display panel 110 and moves his/her finger(s), the cursor 310 move correspondingly with a moving pattern of the finger(s) on the touch display panel 110.

2. When the user clicks on the touch display panel 110 with his/her finger(s), an icon of an APP (i.e. application) indicated by the cursor 310, instead of an icon of an APP at the clicked position on the touch display panel 110, is started or triggered.

3. An effect of enlarging generated by moving a plurality of points (fingers moving away from each other), and/or an effect of shrinking generated by moving a plurality of points (fingers moving toward each other), can be supported, wherein an enlarged/shrunk area can be formed by enlarging or shrinking an area centering at the location of the cursor 310.

4. An effect of switching to a different page by rapidly moving a finger can be supported.

5. Under the second operating mode, the user may be offered to choose among different desktop modes, such that a desktop frame that is output becomes convenient to operate with.

6. Under the second operating mode, a mouse and/or keyboard that is coupled to the external display apparatus 10 can be simultaneously supported, so as to provide the user with more inputting convenience.

In view of the above, the embodiments described above provide the portable apparatus 100. The portable apparatus 100 may determine whether the processing unit 120 switches to the first operating mode or the second operating mode according to whether the portable apparatus 100 is coupled to the external display apparatus. Under the first operating mode, the first reference coordinates generated by the processing unit 120 indicate the position of the touch point on the touch display panel 110. Namely, a position of a single touch point on the touch display panel 110 can be taken as an operating reference position, or a representative position (e.g. a geometrical center point) of a plurality of touch points on the touch display panel 110 can be taken as the operating reference position. The processing unit 120 operates with the first reference coordinates. Under the second operating mode, the processing unit 120 generates the second reference coordinates according to one or more touch points on the touch display panel 110, wherein the second reference coordinates indicate an operating reference position displayed on the frame of the external display apparatus. The processing unit 120 operates with the second reference coordinates, wherein the position of the second reference coordinates is not directly relevant to the position of the touch point on the touch display panel 110, and the second reference coordinates move in response to the movement of the touch point on the touch display panel 110. Therefore, when the portable apparatus 100 and the external display apparatus are coupled, the user may focus on the frame of the external display apparatus, so the operating convenience is improved.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A portable apparatus, comprising:
a touch display panel;
a communication interface; and
a processing unit, coupled to the touch display panel and the communication interface, wherein
when the communication interface is not coupled to an external display apparatus, the processing unit switches to a first operating mode, wherein under the first operating mode, the processing unit generates first reference coordinates according to at least one touch point on the touch display panel and operates according to the first reference coordinates indicating a reference position on a frame displayed by the touch display panel, and the processing unit generates first frame data for being transmitted to the touch display panel, such that the touch display panel displays a frame represented by the first frame data; and
when the communication interface is coupled to the external display apparatus, the processing unit switches to a second operating mode, wherein under the second operating mode, the processing unit generates second reference coordinates according to at least one touch point on the touch display panel and operates according to the second reference coordinates indicating a reference position on a frame displayed by the external display apparatus, and the processing unit generates second frame data for being transmitted to the external display apparatus via the communication interface, such that the external display apparatus displays a frame represented by the second frame data.

2. The portable apparatus as claimed in claim 1, wherein under the first operating mode, the processing unit generates the first reference coordinates according to an absolute position on the touch display panel corresponding to the at least one touch point.

3. The portable apparatus as claimed in claim 1, wherein under the second operating mode, the processing unit generates the second reference coordinates according to a relative position on the touch display panel corresponding to the at least one touch point.

4. The portable apparatus as claimed in claim 1, wherein in the second operating mode, the processing unit generates the second reference coordinates according to a relative position generated by a pointing apparatus coupled to or comprised in the external display apparatus.

5. The portable apparatus as claimed in claim 4, wherein in the second operating mode, the processing unit receives pointing data corresponding to the relative position from the external display apparatus via the communication interface.

6. The portable apparatus as claimed in claim 4, wherein the pointing apparatus is a mouse, a trackball, or a touchpad.

7. The portable apparatus according to claim 3, wherein in the second operating mode, the processing unit further receives an input signal from the external display apparatus via the communication interface and operates in correspondence to the input signal, wherein the input signal is obtained by being generated by an input apparatus and processed by the external display apparatus, the external display apparatus being coupled with or comprising the input apparatus.

8. The portable apparatus as claimed in claim 7, wherein the input apparatus is a keyboard or a touchpad.

9. The portable apparatus according to claim 4, wherein in the second operating mode, the processing unit further receives an input signal from the external display apparatus via the communication interface and operates in correspondence to the input signal, wherein the input signal is obtained by being generated by an input apparatus and processed by the external display apparatus, the external display apparatus being coupled with or comprising the input apparatus.

10. The portable apparatus as claimed in claim 9, wherein the input apparatus is a keyboard or a text input apparatus.

11. The portable apparatus as claimed in claim 1, wherein under the second operating mode, a cursor is displayed at the reference position indicated by the second reference coordinates in the frame represented by the second frame data, wherein the cursor moves in response to a movement of the at least one touch point.

12. The portable apparatus as claimed in claim 11, wherein under the first operating mode, no cursor is displayed at the reference position indicated by the first reference coordinates in the frame represented by the first frame data displayed in the touch display panel.

13. The portable apparatus as claimed in claim 1, wherein under the second operating mode, the second frame data is not transmitted to the touch display panel, such that the touch display panel does not display a frame in accordance with the second frame data.

14. The portable apparatus as claimed in claim 1, wherein under the second operating mode, the processing unit further transmits third frame data to the touch display panel, such that the touch display panel displays a frame represented by the third frame data.

15. The portable apparatus as claimed in claim 14, wherein the second frame data and the third frame data are at least partially identical.

16. The portable apparatus as claimed in claim 14, wherein the second frame data and the third frame data are different.

17. The portable apparatus as claimed in claim 14, wherein the touch display panel and the external display apparatus display a frame of an identical content when the communication interface and the external display apparatus are coupled.

18. The portable apparatus as claimed in claim 14, wherein under the second operating mode, the touch display panel and the external display apparatus display frames of different contents.

19. The portable apparatus as claimed in claim 18, wherein the frame displayed on the touch display panel has a first desktop layout configuration under the first operating mode, and the frame displayed on the external display apparatus has a second desktop layout configuration under the second operating mode, wherein the first desktop layout configuration is different from the second desktop layout configuration.

20. The portable apparatus as claimed in claim 1, wherein for same source image data, a single frame displayed by the external display apparatus under the second operating mode, as compared to a single frame displayed by the touch display panel under the first operating mode, displays more data in the same source image data.

21. The portable apparatus as claimed in claim 20, wherein the more data comprises more page data or more desktop data.

22. The portable apparatus as claimed in claim 21, wherein the more page data comprises data of a larger area in a single page data, or data of more pages in data of a plurality of pages.

23. The portable apparatus as claimed in claim 21, wherein the more desktop data comprises more desktop icons in a single desktop data.

24. The portable apparatus as claimed in claim 1, wherein at least one touch-control operating gesture on the touch display panel is associated to at least one corresponding operation with a first corresponding relation under the first operating mode; and at least one touch-control operating gesture on the touch display panel is associated to at least one corresponding operation with a second corresponding relation under the second operating mode, wherein the first corresponding relation differs from the second corresponding relation.

25. The portable apparatus as claimed in claim 1, wherein under the second operating mode, the frame represented by the second frame data comprises one or more operating links respectively corresponding to one or more operating programs, and the processing unit responding to an operating gesture of starting on the touch display panel by starting an operating program corresponding to the operating link located at the second reference coordinates.

26. The portable apparatus as claimed in claim 1, wherein under the second operating mode, the processing unit responds to an operating gesture of enlarging or shrinking on the touch display panel by enlarging or shrinking a partial area comprising the second reference coordinates.

27. The portable apparatus as claimed in claim 1, wherein a communication protocol run by the communication interface comprises a mobile high-definition link, a high-definition multimedia interface, a universal serial bus, or an Intel wireless display.

28. The portable apparatus as claimed in claim 1, wherein the processing unit adjusts a resolution of the second frame data according to a display resolution sent back from the external display apparatus under the second operating mode.
